(19) United States
(12) Patent Application Publication
(10) Pub. No.: US 2011/0274382 A1
(43) Pub. Date: Nov. 10, 2011

(54) LIGHTWEIGHT HYBRID BEARING ASSEMBLY AND A METHOD OF MAKING THEREOF

(76) Inventors: Mark I. Berns, Northbrook, IL (US); Nick M. Kolar, Chicago, IL (US); Steven S. Williams, Lemont, IL (US)

(21) Appl. No.: 13/100,765

(22) Filed: May 4, 2011

Related U.S. Application Data
(60) Provisional application No. 61/331,562, filed on May 5, 2010.

(51) Int. Cl. F16C 19/26; F16C 43/06; F16C 33/36

(52) U.S. Cl. 384/565; 29/898.062

(57) ABSTRACT

A lightweight hybrid bearing assembly and method of making thereof is disclosed. The bearing assembly includes an inner race and an outer race radially spaced from the inner race. One or both of the inner race and the outer race have a convex bearing surface. Between the inner race and the outer race, a plurality of ceramic roller elements are received. The ceramic roller elements have a concave bearing surface that engages the convex bearing surface or surfaces. Among other things, this accommodates axial misalignment of the races relative to one another.

### CROSS-REFERENCE TO RELATED APPLICATION

This application claims the benefit of provisional patent application Ser. No. 61/331,562 entitled “Lightweight Hybrid Bearing Assembly and a Method of Making Thereof” filed on May 5, 2010. The content of that application is hereby incorporated by reference as if set forth in its entirety herein.

### STATEMENT OF FEDERALLY SPONSORED RESEARCH OR DEVELOPMENT

Not applicable.

### BACKGROUND OF THE INVENTION

This invention relates to bearing assemblies. In particular, this invention relates to bearing assemblies for aerospace applications.

Conventionally, bearing assemblies include an inner race and an outer race which is rotatable relative to the inner race. To minimize the frictional resistance to rotation, a number of rolling elements are positioned between the inner and outer races.

The rolling elements in such bearing assemblies accommodate the controlled rotation of the races relative to one another as well as any connected components to the races. For example, the inner race is often mounted to or received on a shaft and the outer race is often mounted into or received in a housing. When the shaft and housing move relative to one another, the bearing assembly provides bearing surfaces which facilitate smooth rotation and reduce frictional resistance to rotation.

Such bearing assemblies must be able to perform reliably under increasingly demanding application requirements. Traditional bearing assemblies which utilize steel components, while strong, are less than ideal for many applications. Hence, a need exists for improved bearing assemblies.

### SUMMARY OF THE INVENTION

To provide an improved bearing assembly for aerospace applications, a lightweight hybrid bearing assembly has been designed which also has a structure that allows the bearing to be operated in a non-aligned condition.

According to one aspect of the invention, a lightweight hybrid bearing assembly includes an inner race and an outer race that is radially spaced from the inner race. One or both of the inner race and the outer race have a convex bearing surface. A plurality of ceramic roller elements are positioned between the inner race and the outer race. The ceramic roller elements have a concave bearing surface that engages the convex bearing surface.

The lightweight hybrid bearing assembly may be configured to be operable in a misaligned condition in which an axis of the inner race is not aligned with an axis of the outer race. Even within a range of misalignment, the bearing surfaces will remain in contact with one another.

In one form, the inner race may include an outwardly-facing convex bearing surface and the outer race may include one or more inwardly-facing convex bearing surfaces. In this form, the concave bearing surfaces of the plurality of roller elements may engage both the inwardly-facing convex bearing surface(s) of the outer race and the outwardly-facing convex bearing surface of the inner race.

The plurality of ceramic roller elements may have an hourglass shape and may be fabricated from, but not limited to, one or more of Yttria Tetragonal Zirconia Polycrystal (TZP), Yttria Tetragonal Zirconia Polycrystal H [Y-TZP(H)], silicon nitride, and silicon carbide. The plurality of ceramic roller elements may be formed from a sintered ceramic cylinder into which the concave bearing surface has been ground. The ceramic roller elements may be porous.

The inner race and the outer race may comprise titanium, titanium alloy, ceramic, or alloy steel.

Further, the ceramic roller bearings may be in various configurations. The ceramic roller elements may be in a double row annular configuration, single row annular configuration, and/or assembled as part of an assembly including a structure/housing.

In one form, the plurality of ceramic roller elements may include a pair of radially outward facing cylindrical bearing surfaces on either side of the concave bearing surface. The pair of radially outward facing cylindrical bearing surfaces may engage a pair of radially inward facing cylindrical bearing surfaces on the outer race.

According to another aspect of the invention, a method of making a lightweight hybrid bearing assembly of the type described above is also disclosed. The method includes pressing a ceramic powder into a cylindrically-shaped preform, sintering the cylindrically-shaped preform, followed by a hot iso-static process option, and then grinding a concave bearing surface into the cylindrically-shaped preform to thereby form a ceramic roller element. Once the ceramic roller element is formed, a plurality of the ceramic roller elements are positioned between an inner race and an outer race in which at least one of the inner race and the outer race has a convex bearing surface. This convex bearing surface engages the concave bearing surface of the ceramic roller elements.

Again, the ceramic roller elements may have an hourglass shape and may be fabricated from at least one of Yttria Tetragonal Zirconia Polycrystal (TZP), Yttria Tetragonal Zirconia Polycrystal H [Y-TZP(H)], silicon nitride and silicon carbide. The inner race and the outer race may comprise titanium, titanium alloy, ceramic, or alloy steel.

The plurality of ceramic roller elements made by this method may include a pair of radially outward facing cylindrical bearing surfaces on either side of the concave bearing surface. The pair of radially outward facing cylindrical bearing surfaces may engage a pair of radially inward facing cylindrical bearing surfaces on the outer race.

Thus, a lightweight hybrid bearing assembly and a related method of making the bearing assembly are disclosed. This lightweight hybrid bearing assembly provides a low weight component in contrast to traditional steel-based bearing assemblies. Further, as the ceramic roller elements have a concave surface, this allows the inner race to become misaligned with the outer race within a predetermined range of angles and still be operable. As the bearing assembly is operable over a range of misalignment angles, the bearing assembly and attached components are less likely to fail.

These and still other advantages of the invention will be apparent from the detailed description and the drawings. What follows is merely a description of some preferred embodiments of the present invention. To assess the full scope of the invention the claims should be looked to as the preferred embodiments are not intended to be the only embodiments within the scope of the claims.

### BRIEF DESCRIPTION OF THE DRAWINGS

FIG. 1 is a front view of a lightweight double row annular bearing assembly installed into a lightweight housing;

FIG. 2 is a side view of the bearing assembly of FIG. 1 in partial cross section;

FIG. 3 is a front view of another embodiment of a lightweight double row annular bearing assembly; and

FIG. 4 is a side view of the bearing assembly of FIG. 3 in a partial cross section;

FIG. 5 is a single row lightweight annular bearing assembly in a flanged housing;

FIG. 6 is a side view of the bearing assembly of FIG. 5 in a partial cross section; and

FIG. 7 is a block diagram illustrating the steps of making a bearing assembly having a plurality of ceramic roller elements.

### DETAILED DESCRIPTION OF THE PREFERRED EMBODIMENTS

The various aspects of the disclosure are now described with reference to the annexed drawings, wherein like numerals refer to like or corresponding elements throughout. It should be understood, however, that the drawings and the detailed description relating thereto are not intended to limit the claimed subject matter to the particular form disclosed. Rather, the intention is to cover all modifications, equivalents, and alternatives falling within the spirit and scope of the claimed subject matter.

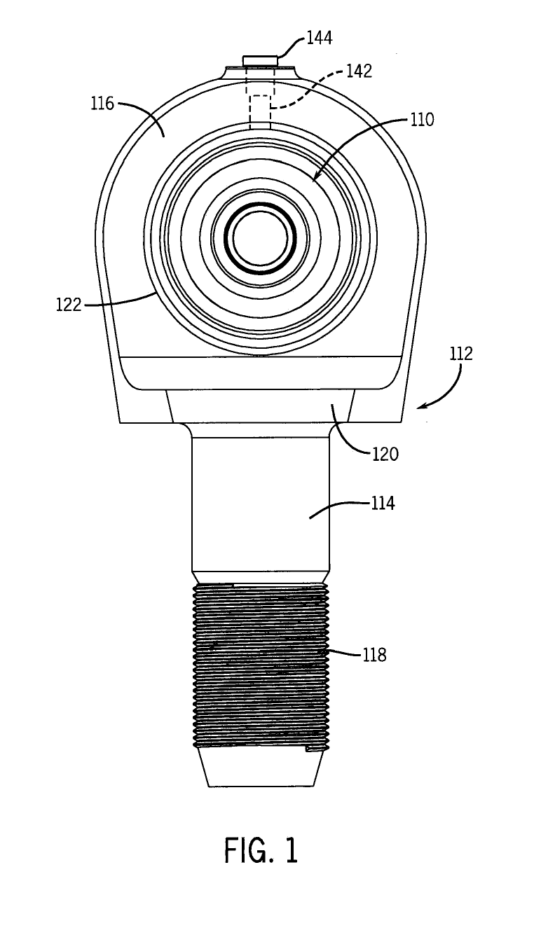

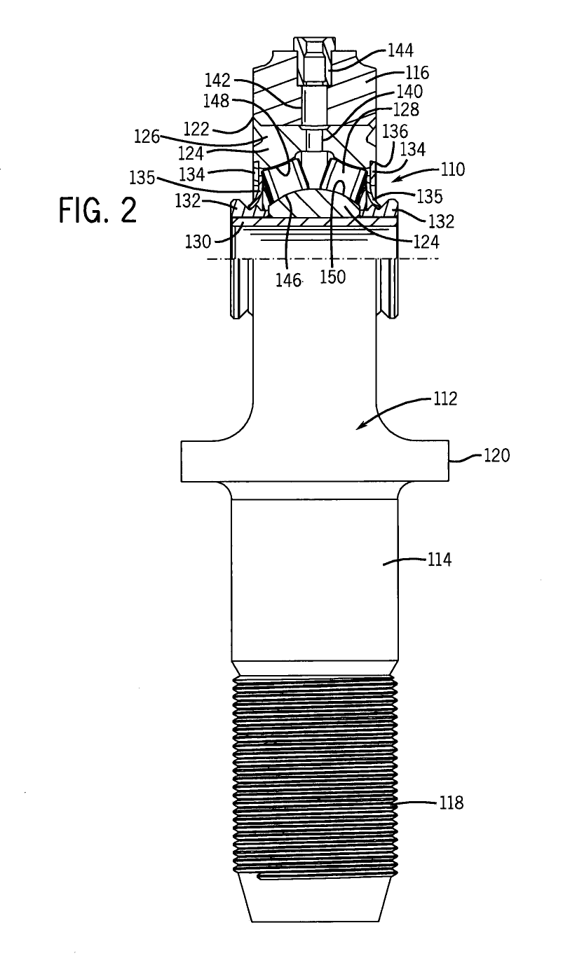

Referring first to FIGS. 1 and 2, a lightweight hybrid bearing assembly 110 is shown inserted into a bearing housing 112. The bearing housing 112 includes a body 114 with a head 116 attached thereto. The body 114 is generally cylindrical in shape and has threads 118 which may be used to screw the bearing housing 112 into a threaded hole of a larger assembly (not shown). Where the body 114 meets the head 116, there is a flanged collar 120 which may limit the insertion depth of the body 114 into the threaded hole.

In a direction perpendicular to the direction of extension of the body 114, the head 116 has a circular opening or eye 122 into which the bearing assembly 110 is inserted. Preferably, the bearing assembly 110 will be dimensioned to have a diameter that is slightly less than the diameter of the eye 122 into which the bearing assembly 110 is received such that the bearing assembly 110 may be swaged into place in the bearing housing 112. Alternatively, the bearing assembly 110 might be lightly press fit into the eye 122 of the bearing housing 112. However, one having ordinary skill in the art will appreciate that even small amounts of deformation to the bearing assembly 110 can, in some instances, have adverse effects on the operation or life of the bearing assembly 110 and, thus, swaging is generally preferred.

As best illustrated in FIG. 2, the bearing assembly 110 includes an inner race 124, an outer race 126 radially spaced from the inner race 124, and a plurality of roller elements 128 received or positioned between the inner race 124 and the outer race 126. The inner race 124 is fit over a central tubular shaft 130 and each axial end of the inner race 124 has one of a pair of collars 132 positioned thereon.

A pair of shields 134 and a pair of elastomeric seals 135 are attached to the races and help to isolate the inner chamber or volume containing the roller elements 128 from the external environment. The pair of shields 134 are attached at the axial ends of the outer race 126 and are generally annularly-shaped. Each of these shields 134 are fixed with respect to the outer race 126 about their outer circumference 136. Likewise, each of the pair of elastomeric seals 135 are attached or connected to one of the collars 132. Each of the pair of elastomeric seals 135 contact one of the pair of shields 134 to form a sealing interface there between. This sealing interface performs the function of preventing the ingress of debris and other particulate matter into the volume between the inner race 124 and the outer race 126 containing the plurality of roller elements 128. Because the shields 134 are not connected to the elastomeric seals 135, the sealing interface is sliding and accommodates the movement of the inner race 124 relative to the outer race 126 while maintaining the seal. Although specific shield/seal combinations are shown, it will be appreciated that other shield/seal arrangements and improvements might be utilized in a bearing of the type disclosed.

A radial lubrication channel 140 is formed in the outer race 126 of the bearing assembly 110 which is in fluid communication with an inner chamber or volume defined by the inner race 124, the outer race 126, the pair of shields 134, and the pair of elastomeric seals 135. This radial lubrication channel 140 is aligned with a separate radially-extending lubrication channel 142 formed in the bearing housing 112, such that when a plug 144 is removed from the radially-extending lubrication channel 142, then a lubricant may be supplied to the inner chamber and bearing surfaces.

Notably, each of the roller elements 128 are formed to have a concave bearing surface 146 such that the roller elements 128 may be said to have an hourglass shape in which the diameter of the roller element 128 is smaller in the center than on either of the axial ends. As the particular bearing assembly 110 shown in FIGS. 1 and 2 is of a double row annular configuration, the outer race 126 includes a pair of radially inwardly facing convex bearing surfaces 148 which engage the concave bearing surface 146 of the roller elements 128. The inner race 124, however, includes a single convex bearing surface 150 which extends the axial length of the inner race 124. The concave bearing surface 146 of each of the roller elements 128 also engage this convex bearing surface 150 on the inner race 124. This structural configuration allows the inner race 124 to become axially misaligned with respect to the outer race 126 while the bearing assembly 110 remains operable such that the inner race 124 can generally axially rotate within the outer race 126. As the roller elements 128 have a concave bearing surface 146, the roller elements 128 will stay substantially in the pair the convex bearing surfaces 148 in the outer race 126 as the outer race 126 moves with the roller elements 128 during any misalignment. Accordingly, when axis of rotation of the outer race 126 tilts with respect to the axis of rotation of the inner race 124, the concave bearing surfaces 146 of the roller elements 128 will travel along the convex bearing surface 150 of the inner race 124 while the surfaces maintaining bearing engagement with one another. The collars 132 on either side of the inner race 124 form stops which restrict the range of axial misalignment. In one form, the axial misalignment of the axis of the inner race 124 with respect to the axis of the outer race 126 may be up to 10 degrees.

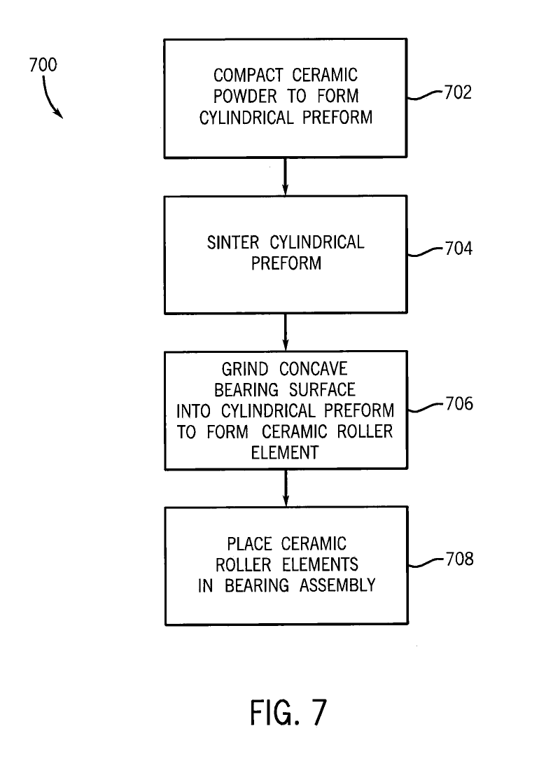

In the embodiment shown, the roller elements 128 are formed of s ceramic material. Preferably, the ceramic material may be one of Yttria Tetragonal Zirconia Polycrystal (TZP), Yttria Tetragonal Zirconia Polycrystal H [Y-TZP(H)], silicon nitride, or silicon carbide. With additional reference to FIG. 7 which illustrates a method of making a ceramic roller element and bearing assembly, the ceramic roller elements 128 are formed by compacting or pressing a ceramic powder in a die set to form a cylindrically-shaped preform according to step 702. The cylindrically-shaped preform is then sintered to densify the preform and to bond the particulates of the ceramic powder together according to step 704. Next, if reduced porosity is desired, there is an option to route the preforms through a hot iso-static process. Then, the sintered cylindrically-shaped preform is ground according to step 706 using a diamond-formed grinding wheel to form the concave bearing surface 146, thereby forming a ceramic roller element such as that as found in the bearing assembly 110. During assembly of the bearing assembly according to step 708, the plurality of the ceramic roller elements 128 are positioned between the inner race 124 and the outer race 126. One or both of the inner race 124 and the outer race 126 have convex bearing surfaces 148, 150 which engage the concave bearing surface 146 of the ceramic roller elements 128 in the manner described above.

The inner race 124 and the outer race 126 are formed of a lightweight, but high strength metallic material such as titanium, titanium alloy, or alloy steel. A titanium alloy housing, in combination with the ceramic roller elements, offers a significant weight reduction over a standard steel bearing assembly. Alternatively, one or both of the races might be made of a ceramic material or coated therewith.

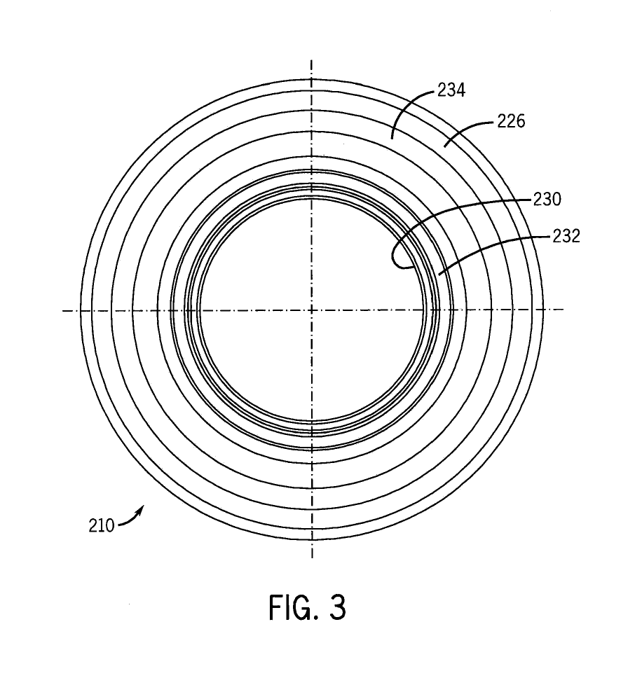

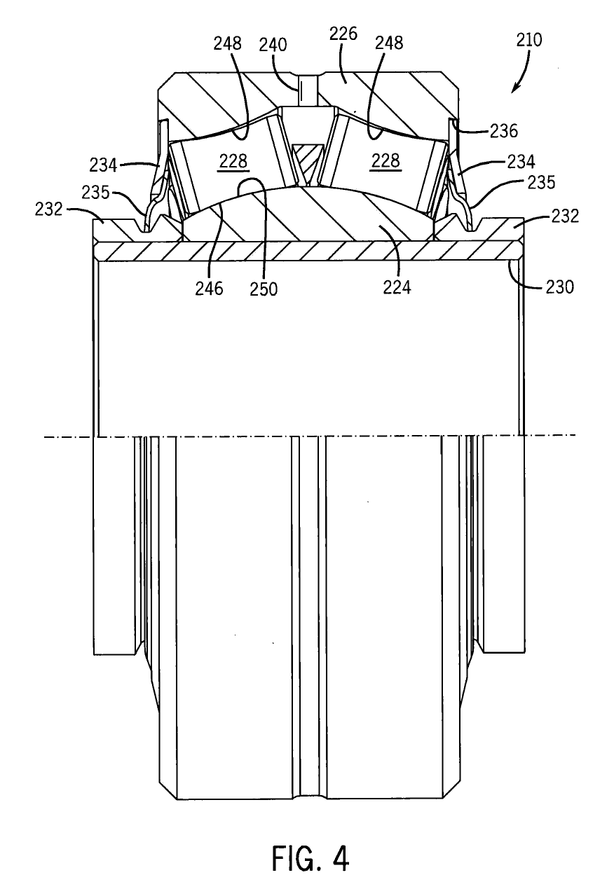

Referring now to FIGS. 3 and 4, another bearing assembly 210 is illustrated which is similar to the bearing assembly 110 in many ways, including the materials from which the components are fabricated. Unlike the bearing assembly 110, the bearing assembly 210 is not placed in a bearing housing. The particular dimensions and shapes of the bearing assembly 210 may differ from those of the bearing assembly 110 to better match a particular use or application for the assembly.

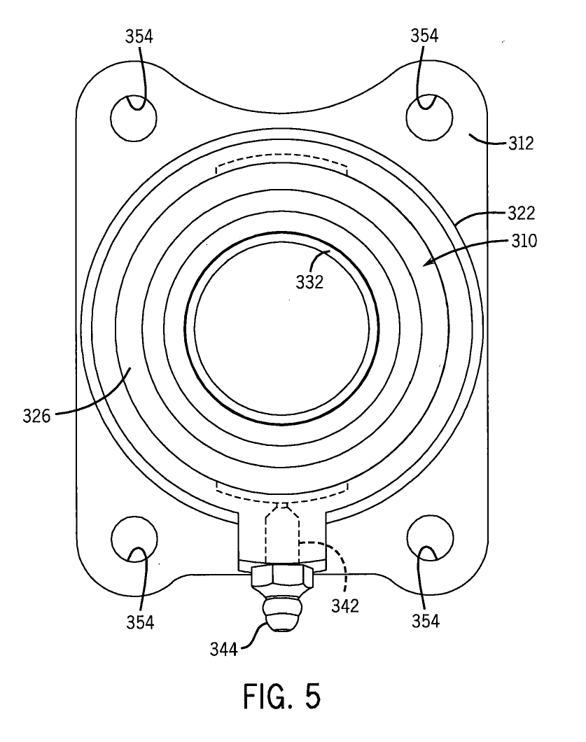

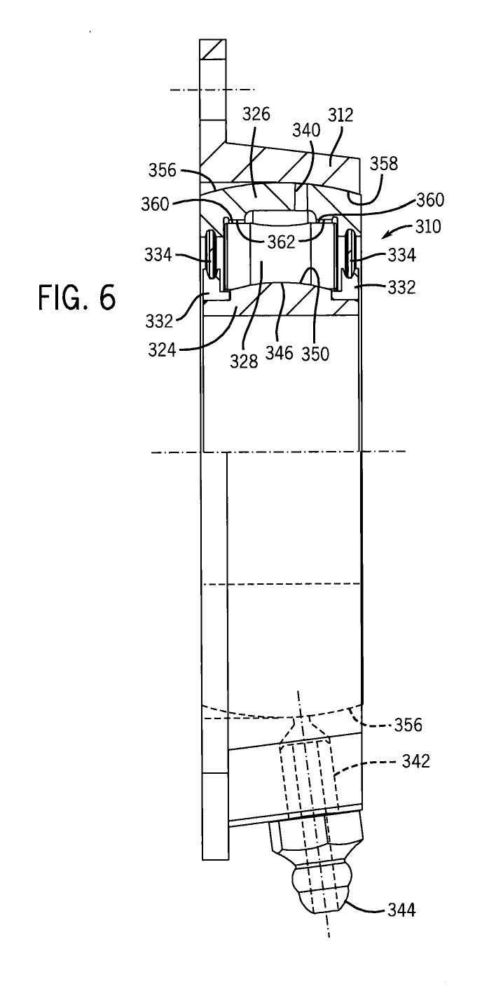

Now with reference to FIGS. 5 and 6, yet another bearing construction is shown having a bearing assembly 310 inserted into a flanged housing 312, The flanged housing 312 has a set of four mounting through-holes 354.

Unlike the previously described bearing assemblies, the bearing assembly 310 has an outer race 326 with an outer periphery 356 which is convexly curved along the axial direction. The flanged housing 312 includes a convexly shaped inner periphery 358 which partially matches this curvature. By mounting the back side of the flanged housing 312 to a flat surface (not shown), the outer periphery 356 of the outer race 326 of the bearing assembly 310 contacts the inner periphery 358 such that upon contacting one, another their curvature holds or captures the bearing assembly 310 in place relative to the bearing housing 312 and the flat surface.

With particular reference to FIG. 6, another unique aspect of this bearing assembly 310 can be seen. The bearing assembly 310 includes only a single row of annularly arranged rolling elements 328. However, these rolling elements 328 differ from the previous rolling elements in that these rolling elements 328 include a pair of radially outward facing cylindrical bearing surfaces 360 on either side of the concave bearing surface 346. Although the rolling elements of the previously described embodiments included smaller radially outward facing cylindrical surface as artifacts of the fabrication process, those surfaces did not substantially bear on any race surface. In the embodiment shown in FIG. 6, however, the pair of radially outward facing cylindrical bearing surfaces 360 engage a pair of axially-separated radially inward facing cylindrical bearing surfaces 362 on the outer race 326. Further, on the lateral sides of the outer race 326 are stops which limit the axial movement of the rolling elements 328 relative to the outer race 326. Thus, when axial misalignment occurs, the roller elements 328 travel in the channel of the outer race 326 and the inner race 324 alone tilts with respect to the rolling elements 328.

Thus, a lightweight hybrid bearing assembly is disclosed. This lightweight hybrid bearing assembly provides a low weight component in contrast to traditional steel-based bearing assemblies which are comparatively heavy. Further, as the ceramic roller elements have a concave surface, this allows the inner race to become misaligned with the outer race within a predetermined range of angles and still be operable. As the bearing assembly is operable over a range of axial misalignment, the bearing assembly and attached components are less likely to fail. The rolling elements are fabricated in a unique manner from a ceramic material to have a concave bearing surface. A bearing assembly of this type with these stated advantages is heretofor unknown.

It should be appreciated that various other modifications and variations to the preferred embodiments can be made within the spirit and scope of the invention. Therefore, the invention should not be limited to the described embodiments. To ascertain the full scope of the invention, the following claims should be referenced.

1. A lightweight hybrid bearing assembly comprising:
an inner race;
an outer race radially spaced from the inner race, wherein at least one of the inner race and the outer race have a convex bearing surface; and
a plurality of ceramic roller elements positioned between the inner race and the outer race, the plurality of ceramic roller elements having a concave bearing surface that engages the convex bearing surface.

2. The lightweight hybrid bearing assembly of claim 1, wherein the lightweight hybrid bearing assembly is configured to be operable in a misaligned condition in which an axis of the inner race is not aligned with an axis of the outer race.

3. The lightweight hybrid bearing assembly of claim 1, wherein the inner race includes an outwardly-facing convex bearing surface, the outer race includes an inwardly-facing convex bearing surface, and the concave bearing surface of the plurality of roller elements engages both the inwardly-facing convex bearing surface of the outer race and the outwardly-facing convex bearing surface of the inner race.

4. The lightweight hybrid bearing assembly of claim 1, wherein the plurality of ceramic roller elements have an hourglass shape.

5. The lightweight hybrid bearing assembly of claim 1, wherein the plurality of ceramic roller elements are fabricated from at least one of Yttria Tetragonal Zirconia Polycrystal (TZP), Yttria Tetragonal Zirconia Polycrystal H [Y-TZP(H)], silicon nitride, and silicon carbide.

6. The lightweight hybrid bearing assembly of claim 1, wherein the inner race and the outer race comprise titanium.

7. The lightweight hybrid bearing assembly of claim 1, wherein the inner race and the outer race comprise a titanium alloy.

8. The lightweight hybrid bearing assembly of claim 1, wherein at least one of the inner race and the outer race comprise a ceramic material.

9. The lightweight hybrid bearing assembly of claim 1, wherein at least one of the inner race and the outer race comprise an alloy steel.

10. The lightweight hybrid bearing assembly of claim 1, wherein the plurality of ceramic roller elements are in a double row annular configuration.

11. The lightweight hybrid bearing assembly of claim 1, wherein the plurality of ceramic roller elements are in a single row annular configuration.

12. The lightweight hybrid bearing assembly of claim 1, wherein the plurality of ceramic roller elements are formed from a sintered ceramic cylinder into which the concave bearing surface is ground.

13. The lightweight hybrid bearing assembly of claim 12, wherein the plurality of ceramic roller elements are porous.

14. The lightweight hybrid bearing assembly of claim 1, wherein the plurality of ceramic roller elements include a pair of radially outward facing cylindrical bearing surfaces on either side of the concave bearing surface and wherein the pair of radially outward facing cylindrical bearing surfaces engages a pair of radially inward facing cylindrical bearing surfaces on the outer race.

15. A method of making a lightweight hybrid bearing assembly, the method comprising:
pressing a ceramic powder into a cylindrically-shaped preform;
sintering the cylindrically-shaped preform;
grinding a concave bearing surface into the cylindrically-shaped preform to thereby form a ceramic roller element; and
positioning a plurality of the ceramic roller elements between an inner race and an outer race in which at least one of the inner race and the outer race has a convex bearing surface which engages the concave bearing surface of the ceramic roller elements.

16. The method of claim 15, wherein the plurality of ceramic roller elements have an hourglass shape.

17. The method of claim 15, wherein the plurality of ceramic roller elements are fabricated from at least one of Yttria Tetragonal Zirconia Polycrystal (TZP), Yttria Tetragonal Zirconia Polycrystal H [Y-TZP(H)], silicon nitride, and silicon carbide.

18. The method of claim 15, wherein the inner race and the outer race comprise at least one of titanium and an alloy steel.

19. The method of claim 15, wherein at least one of the inner race and the outer race comprise a ceramic material.

20. The method of claim 15, wherein the plurality of ceramic roller elements include a pair of radially outward facing cylindrical bearing surfaces on either side of the concave bearing surface and wherein the pair of radially outward facing cylindrical bearing surfaces engages a pair of radially inward facing cylindrical bearing surfaces on the outer race.

21. The method of claim 15, further comprising, after the sintering step, performing a hot iso-static process on the preform.
